(19) United States
(12) Patent Application Publication
(10) Pub. No.: US 2026/0133790 A1
(43) Pub. Date: May 14, 2026

(54) VEHICLE FEATURE ACTIVATION SYSTEM

(71) Applicant: Rivian IP Holdings, LLC, Irvine, CA (US)

(72) Inventors: Ashkan HADIAN, Granada Hills, CA (US); Adam Wade ARSENAULT, West Vancouver (CA); Daniel SANTOS, San Jose, CA (US); Venkata Sunil Kishore Gupta PADAKANTI, San Ramon, CA (US); Sunil BHAGWATH, Dublin, CA (US); Abdallah MOHAMMED, Irvine, CA (US); Vamsi Krishna RAVULAPALLI, Dublin, CA (US); Atrayee NAG, Irvine, CA (US); Akshat VASUDEV, Irvine, CA (US)

(21) Appl. No.: 19/380,736

(22) Filed: Nov. 5, 2025

Related U.S. Application Data
(60) Provisional application No. 63/719,074, filed on Nov. 11, 2024.

(51) Int. Cl. G06F 8/65; G06F 9/445

(52) U.S. Cl. CPC G06F 8/65; G06F 9/4451

(57) ABSTRACT

A vehicle includes a controller configured to connect to a network and further configured to receive a feature activation request referencing an owner. The controller is configured to publish an event including the feature activation request on an event network. Each component of a plurality of components of the vehicle is configured to, if the each component is the owner referenced by the feature activation request of the event, execute the feature activation request. The plurality of components may be electronic control units (ECUs). The each component may be configured to execute the feature activation request by activating a feature that is present on the each component prior to receiving the feature activation request by the controller and without reflashing the each component. The each component may publish events for processing by other components in response to the feature activation request.

### RELATED APPLICATION

This application claims the benefit of U.S. Provisional Patent Application Ser. No. 63/719,074 filed Nov. 11, 2024, and entitled VEHICLE FEATURE ACTIVATION SYSTEM, which is hereby incorporated by reference in its entirety.

### FIELD OF THE INVENTION

This application relates to a vehicle feature activation system.

### SUMMARY

In one aspect, a vehicle includes a plurality of components. The vehicle includes a controller configured to connect to a network and further configured to receive a feature activation request referencing an owner. The controller is configured to publish an event including the feature activation request on an event network. Each component of the plurality of components is configured to, if the each component is the owner referenced by the feature activation request of the event, execute the feature activation request.

In some embodiments, the plurality of components includes electronic control units (ECUs).

In some embodiments, the each component is further configured to execute the feature activation request by activating a feature that is present on the each component prior to receiving the feature activation request by the controller.

In some embodiments, the each component is further configured to execute the feature activation request without reflashing the each component.

In some embodiments, the event network comprises a publisher/subscriber network.

In some embodiments, the each component is a subscriber of the publisher/subscriber network and is configured to detect the event based on the event referencing a component identifier (CID) of the each component.

In some embodiments, the controller executes an application, the controller further configured to receive a configuration change from a user and transmit the configuration change to a remote computer system in response to the configuration change from the user. The feature activation request may be received from the remote computer system in response to the configuration change.

In some embodiments, the remote computer system is a cloud computing platform.

In some embodiments, the each component of the plurality of components is further configured to verify that one or more interlocks are met before executing the feature activation request.

In some embodiments, the event is a first event and the each component is further configured to execute the feature activation request by publishing one or more second events on the event network, the one or more second events referencing one or more other components of the plurality of components.

In another aspect, a method includes receiving, by a vehicle controller of a vehicle, a feature activation request referencing an owner. The method includes publishing, by the vehicle controller, an event including the feature activation request on an event network. The method includes determining, by a component of a plurality of components of the vehicle, that the component is the owner. The method includes in response to determining that the component is the owner, executing, by the component, the feature activation request.

In some embodiments, the plurality of components includes electronic control units (ECU).

In some embodiments, the method further includes executing, by the component, the feature activation request by activating a feature that is present on the component prior to receiving the feature activation request by the controller.

In some embodiments, the method further includes executing, by the component, the feature activation request without reflashing the component.

In some embodiments, the event network is a publisher/subscriber network.

In some embodiments, the component is a subscriber of the publisher/subscriber network, the method further comprising detecting, by the component, the event due to the event referencing a component identifier (CID) of the each component.

In some embodiments, the method further includes receiving, by an application executed by the vehicle controller, a configuration change from a user and transmitting, by the application, the configuration change to a remote computer system in response to the configuration change from the user. The feature activation request may be received from the remote computer system in response to the configuration change.

In some embodiments, the method further includes verifying, by the component, that one or more interlocks are met before executing the feature activation request.

In some embodiments, the event is a first event and the method further comprising executing, by the component, the feature activation request by publishing one or more second events on the event network, the one or more second events referencing one or more other components of the plurality of components.

In another aspect, a non-transitory computer-readable medium storing executable code that, when executed by a vehicle controller and a plurality of components of a vehicle, causes the vehicle controller and the plurality of components of the vehicle to: receive, by the vehicle controller, a feature activation request referencing an owner; publish, by the vehicle controller, an event including the feature activation request on an event network; determine, by a component of the plurality of components of the vehicle, that the component is the owner; and in response to determining that the component is the owner, execute, by the component, the feature activation request.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIGS. 3A to 3C are schematic diagrams illustrating approaches for activating features of a vehicle in accordance with certain embodiments.

FIG. 3D is a process flow diagram of a method for activating features of a vehicle in accordance with certain embodiments.

FIG. 4 illustrates a system for providing proximity services to vehicles in accordance with certain embodiments.

FIG. 5 illustrates a method of providing proximity services to vehicles in accordance with certain embodiments.

### DETAILED DESCRIPTION

Over-the-air (OTA) updates have become a common way to improve the functionality of a vehicle. Software of an electronic control unit (ECU) or other component of a vehicle may be updated remotely using an OTA. Using the approach disclosed herein, features present on the vehicle may be selectively activated subsequent to an OTA or installation upon manufacture.

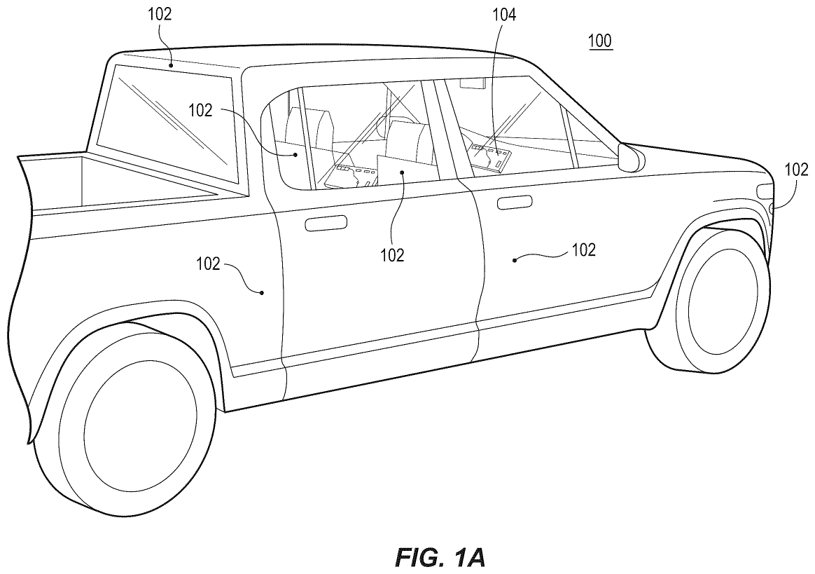

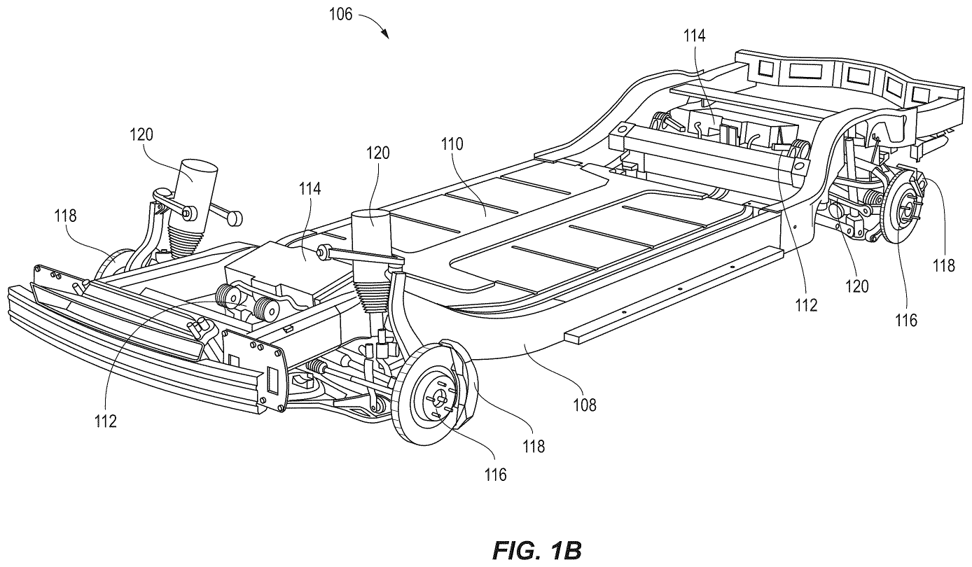

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

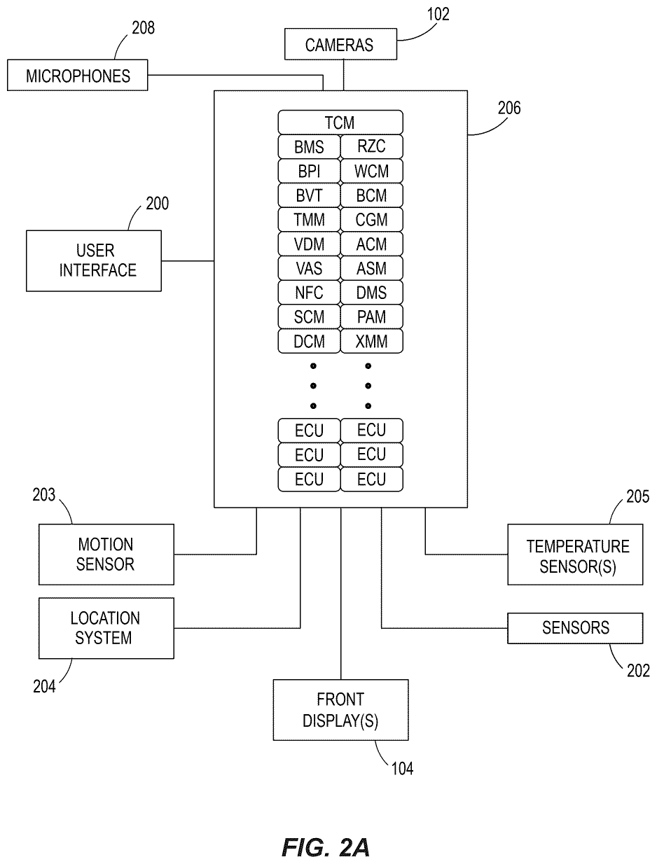

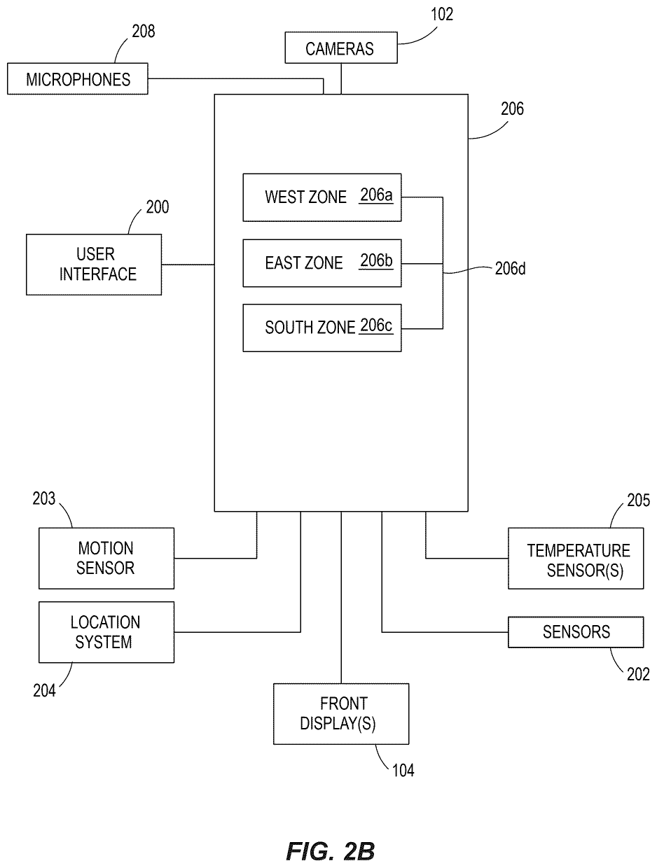

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

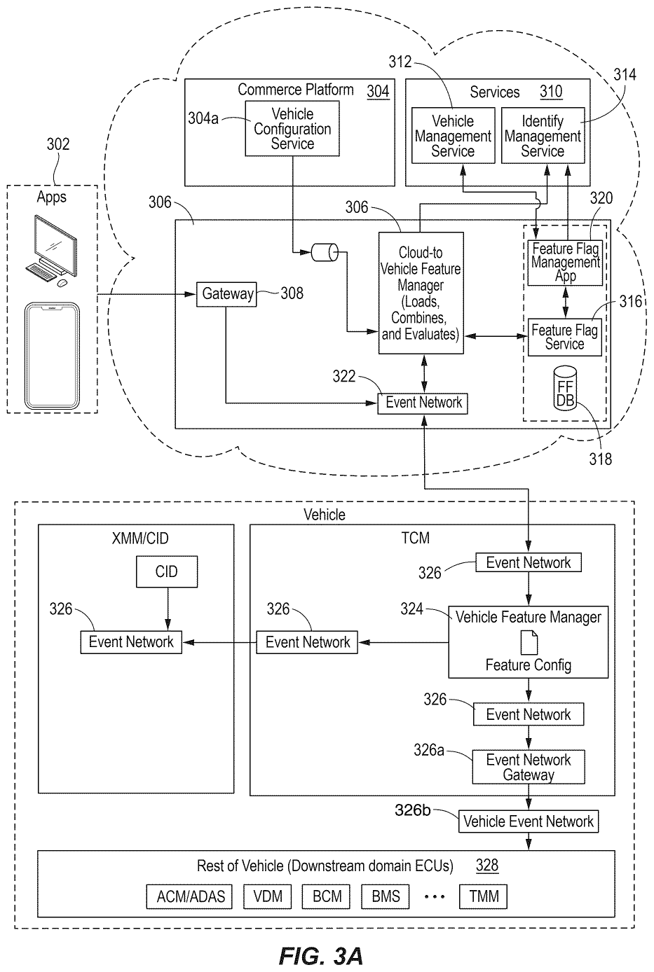

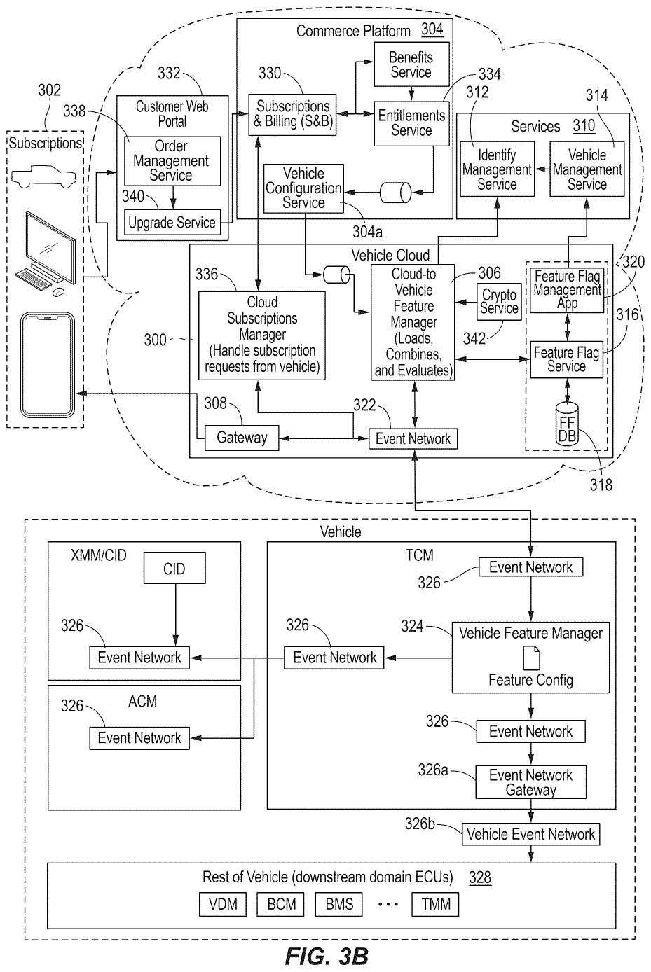

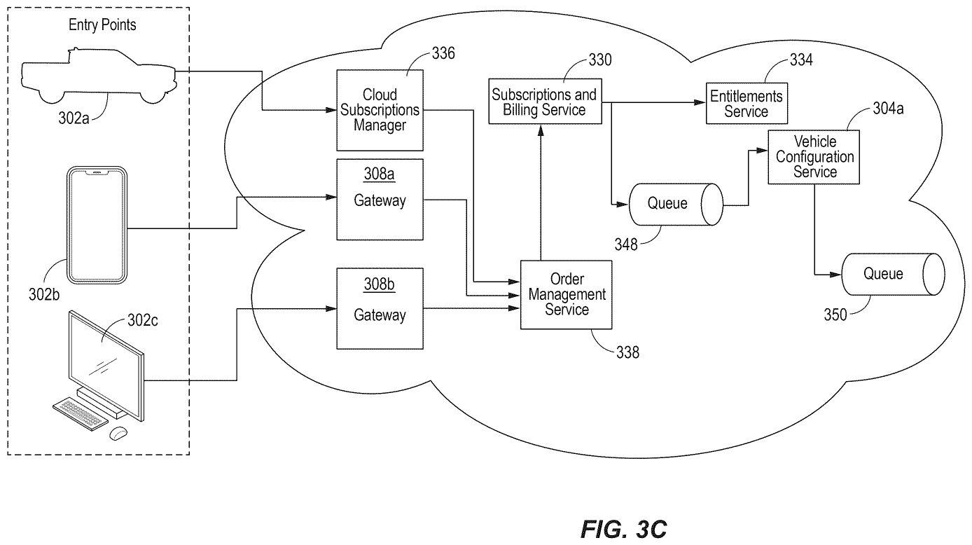

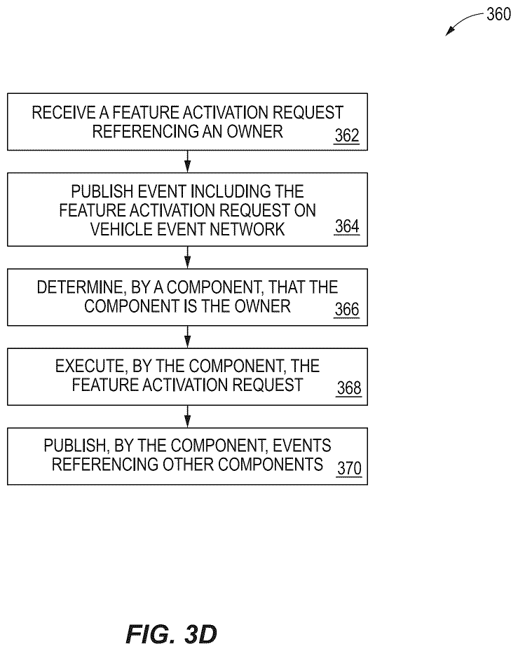

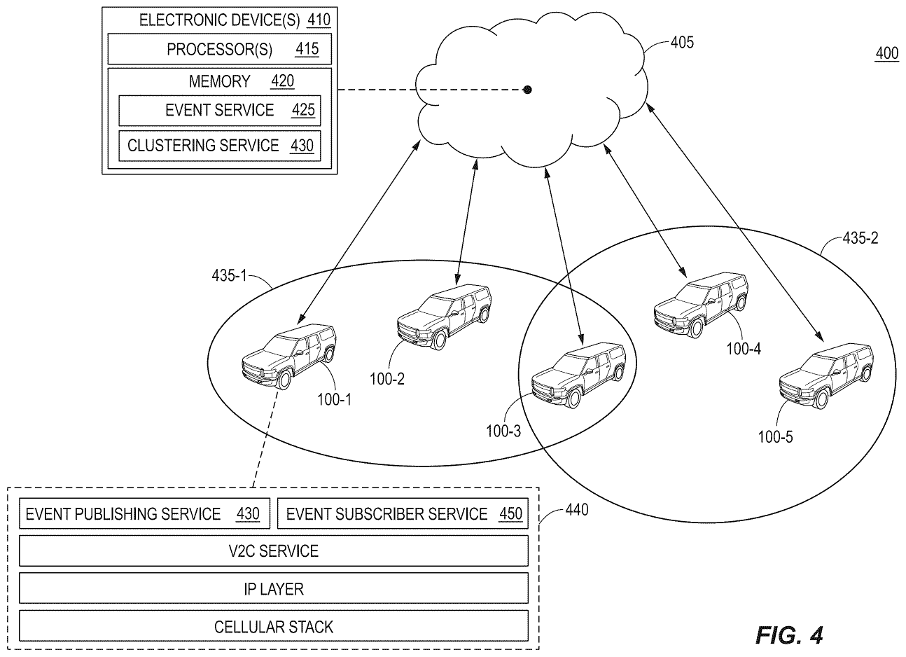

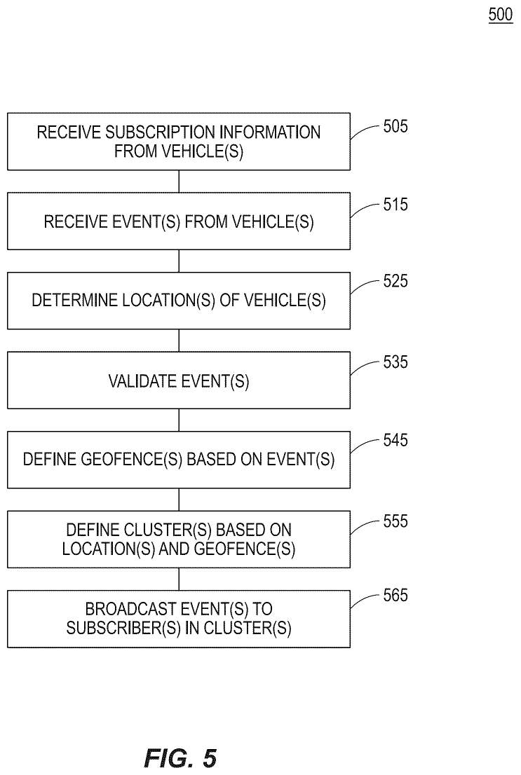

A control system 206 executes instructions to perform at least some of the actions or functions of the vehicle 100, including the functions described in relation to FIGS. 4 and 5. For example, as shown in FIG. 2, the control system 206 may include one or more electronic control units (ECUs) configured to perform at least some of the actions or functions of the vehicle 100, including the functions described in relation to FIGS. 3A to 5. In certain embodiments, each of the ECUs is dedicated to a specific set of functions. Each ECU may be a computer system, and each ECU may include functionality described below in relation to FIGS. 3A to 5.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described in relation to FIGS. 3A to 5.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

FIGS. 3A to 3C illustrate an approach for remotely activating and deactivating features within a vehicle, where software and hardware implementing the features are already present in the vehicle prior to activation and may remain following deactivation. Activation and deactivation may be performed in real time in response to inputs from a user or manufacture.

A remote computer system, such as a cloud computing platform (hereinafter “vehicle cloud 300”), may be used to communicate with a vehicle 100. A user may request activation (generate a “feature activation request”) of a feature that is already installed on the vehicle 100, such as on one or more ECUs of the vehicle 100, other component of the control system 206, or other software module executing anywhere on the vehicle prior to receiving the feature activation request. For example, the user may purchase or otherwise request activation of the feature by providing inputs to an application 302 on a mobile device, a website, an interface implemented by the vehicle 100 itself, or other modality.

Example features may include detailed satellite maps, extended range for a battery 110, increased torque output from a motor, self-driving functionality, content (e.g., for information or entertainment), seasonal themes (e.g., Halloween-inspired lighting sequences and/or themes and/or interface design).

Another example of an activatable feature is vehicle-to-vehicle (V2V) communications technology that enables operational data to be wirelessly transmitted between vehicles, which can be used to alert drivers in real-time about potential dangers, such as dangerous traffic and road conditions, terrain issues, and weather threats. Conventionally, V2V typically uses Dedicated Short-Range Communications (DSRC) supporting communications within a limited range (e.g., about 300 meters). DSRC provides very low latency communications, on the order of tens of milliseconds (ms). However, many events that are communicated between vehicles are routine, and do not have an urgency (or criticality) demanding such low latency. Further, advancements in cellular networks, including newer architectures such as edge computing, support increased speeds and improved functionality for communications between vehicles.

A commerce platform 304 may receive a configuration change, e.g., a high-level description that corresponds to one or more feature activation requests, and process payment if necessary. The commerce platform 304 may transmit the configuration change to a cloud-to-vehicle feature manager 306. The commerce platform 304 may include a vehicle configuration service 304a that receives the high-level description of a features, e.g., a package of features, configuration level, or other descriptor and generates corresponding one or more feature activation requests corresponding to the package, configuration level, or other descriptor. The vehicle configuration service 304a may determine which aspects of a software configuration change received from an application 302 require a feature activation and generate corresponding feature activation requests.

A configuration change may also be received by a gateway 308 and routed to the cloud-to-vehicle feature manager 306. The cloud-to-vehicle feature manager 306 may also receive configuration changes generated by services 310 of an enterprise, e.g., to activate features in response to a change in policy, natural disaster, to enhance safety or reliability of the vehicle 100, to provide a free trial, or other business reason. The services 310 may include a vehicle management service 312 and an identity management service 314. The vehicle management service 312 is discussed in detail below and may manage the pushing of configuration changes in the form of updates (e.g., over-the-air (OTA) updates) to vehicles 100. The identity management service 314 may manage authenticating a vehicle and possibly an owner of a vehicle to facilitate authenticated exchange of data between the vehicle cloud 300 and the vehicle 100.

The cloud-to-vehicle feature manager 306 may load, combine, and/or evaluate feature activation requests. The cloud-to-vehicle feature manager 306 may provide at least a portion of the feature activation requests to a feature flag service 316, which stores the feature activation requests in a feature flag database 318. For example, the feature activation requests may be associated with a specific vehicle or class of vehicles in the feature flag database 318.

One or more components may be used to verify that a feature activation request is possible and/or permitted for a particular vehicle identifier or class of vehicle associated with a feature activation request (e.g., associated with a user account that generated the feature activation request or explicitly included in the feature activation request). For example, a vehicle management service 312 may perform this verification or another component, such as a feature flag management application 320. Feature activation requests that are verified for a vehicle identifier or class of vehicle may be added to the feature flag database 318 whereas those that are not added to the feature flag database and may trigger an error message to the source of the feature activation request.

When a vehicle 100 having the vehicle identifier or belonging to the class of vehicle associated with a feature activation request connects to the vehicle cloud 300, entries of the feature flag database 318 referencing that vehicle identifier or vehicle class are downloaded by the vehicle 100 and used to activate features on that vehicle 100, such as in the form of a package of feature activation requests. There may be multiple feature activation requests in the feature flag database in association with the vehicle identifier and that may be bundled together and transmitted to the vehicle 100. The cloud-to-vehicle feature manager 306 may transmit feature activation requests to the vehicle 100 using an event network 322 that implements a publisher/subscriber model in which components publish events that are then provided to subscribers. For example, the vehicle 100 may be a subscriber of the cloud-to-vehicle feature manager 306.

Feature activation requests received from the cloud-to-vehicle feature manager 306 may be received by a vehicle feature manager 324 on the vehicle 100, such as by way of a vehicle event network 326. For example, the vehicle feature manager 324 may be a subscriber to events on the event network 322 that reference an identifier of the vehicle 100. The vehicle event network 326 may likewise implement a publisher/subscribe model in which components of the vehicle 100 may publish events and other components may subscribe to receive such events. For example, any of the ECUs of the control system 206 may be publishers and/or subscribes of the vehicle event network 326.

Each feature activation request received from the cloud-to-vehicle feature manager 306 may be labeled with an owner. The owner may be a specific component targeted by the feature activation request, such as a specific ECU or other software or hardware component. The vehicle feature manager 324 may therefore route each feature activation request to the owner indicated by the label. The vehicle feature manger may route the feature activation requests by publishing feature activation requests on the vehicle event network 326.

The owner of the feature activation request may receive the feature activation request, activate the feature referenced by the feature activation request, and notify the vehicle feature manager 324 that the feature has successfully been activated. If the owner cannot successfully activate the feature, the owner may notify the vehicle feature manager 324 of this fact, which may include a specific error generated by the owner when attempting to activate the feature.

The vehicle feature manager 324 may return a result of the feature activation request (successful or unsuccessful) to the cloud-to-vehicle feature manager 306. The cloud-to-vehicle feature manager 306 may return the result to a source of a configuration change that resulted in the feature activation request, e.g., webpage, application, or interface of the vehicle 100. The cloud-to-vehicle feature manager 306 may additionally store a result, particularly an unsuccessful result for future reference, e.g., for troubleshooting, to invoke repair, or to suppress further attempts to activate that feature for the vehicle identifier or class of vehicle associated with the feature activation request. The vehicle 100 may preemptively evaluate itself for capacity to activate a feature. In the event that the vehicle 100 finds that the vehicle 100 is unable to activate a feature, the vehicle 100 may communicate this fact to the cloud-to-vehicle feature manager 306, which will then suppress subsequent attempts to activate the feature on the vehicle 100.

The owner of the feature may already have the feature installed and inactive. Accordingly, activation of the feature may be performed without restarting the owner or other reprogramming, e.g., reflashing. Since the feature is already installed, the activation may be nearly instantaneous from the point of view of the user following generation of an activation request, such as within 2 seconds, 1 seconds, 500 milliseconds, or 100 milliseconds, depending on network delays. The owner may implement interlocks prior to activating the feature, such as requiring that the vehicle be stopped, in park, turned off, or meet some other requirement. Accordingly, activation may be delayed until such interlocks are met. The owner of the feature may also perform hardware verifications to ensure that required hardware components are present and functional. If not, the owner of the feature may report an unsuccessful result, which may indicate which hardware verifications failed.

In the illustrated example, a component, such as the experience management module (XMM) is assigned a component identifier (CID). The XMM is a subscriber on the event network 326 and is subscribed to receive any event including the CID of the XMM as the owner of that event. Accordingly, the XMM will receive feature activation requests on the event network 326 that include the CID and, in response, activate features of the XMM as indicated in the feature activation request.

The rest of the vehicle, e.g., downstream domain ECUs 328, may likewise be subscribers to an event network 326b (e.g., any of the ECUs discussed above with respect to FIGS. 2A and 2B) and receive and process feature activation requests including the CID thereof in a like manner. In the illustrated embodiment, the TCM is connected to event networks 322, 326, and 326b. For example, the event networks 322, 326 may be a single event network with the event network 326 receiving only events from the event network 322 that relate to the vehicle 100. The event network 326b may provide a messaging interface for communicating events between the downstream domain ECUs 328 and the TCM. In the illustrated embodiment, the TCM may implement an event network gateway 326a connected to the event network 326b and that transmits events from the event network 326 to the downstream domain ECUs 328 and receives responses from the downstream domain ECUs 328.

The owner of the feature may be programmed to invoke activation of the feature with respect to one or more other vehicle components, e.g., the feature may be implemented across multiple components with one of such components being the owner. The owner may therefore output instructions to the other components to activate the feature, such as using the vehicle event network. The owner may expose or advertise an interface through which other components may interact with the owner to activate the feature, e.g., where coordination is required. The other components may then attempt to activate the feature (e.g., the portion of the feature implemented thereby) and return a result of the attempt, e.g., successful or unsuccessful. The owner may return a result of activating the feature based on results received from the other components, e.g., returning a notification of successful activation only upon receiving notification of success from the other components as well as successful activation on the owner itself. Otherwise, the owner may return a notification of unsuccessful activation, which may indicate which components failed to activate the feature.

In one example of multiple components being implicated by a feature, a feature may impact an ECU, such as the vehicle dynamics module (VDM) but also be controllable using an interface provided by the experience management module (XMM). Accordingly, the VDM may be the owner and coordinate with the XMM to activate the interface corresponding to a feature.

In some embodiments, the TCM is listed as the owner of each feature activation request received from the event network 322. Feature activation requests received from the event network 322 that do not relate to features of the TCM itself may instruct the TCM to generate events including other feature activation requests referencing different owners, such as another ECU, such as the XMM, VDM, or any of the downstream domain ECUs 328. The other feature activation requests may be transmitted as events on the vehicle event network 326 or vehicle network 326b as part of executing the other feature activation requests.

Referring specifically to FIG. 3B, an application 302, such as a mobile application, web application with a corresponding webpage, or application executing on the vehicle 100 itself, may be a subscriber to events on the event network 322 and may therefore receive notification of events. For example, the application 302 may subscribe to events relating to a specific vehicle identifier and possibly specific types of events for that vehicle identifier. In this manner, the application 302 may receive events indicating successful or unsuccessful activation of a feature. The application may display result of attempts to activate a feature in the same interface used to send a configuration change that invoked generation of the feature activation request.

The availability of features that can be activated for a vehicle identifier, such as by purchase, may likewise be communicated to application 302 using the event network 322. These features may then be displayed in an interface of the application 302.

Referring to FIG. 3B, a commerce platform 304 may include a subscriptions and billing module 330 configured to interact with a customer web portal 332 to handle signing up for subscriptions and billing for subscriptions for activation of features. Features that a user has purchased for a vehicle identifier or is otherwise entitled to use may be recorded in an entitlement service 334. Changes to the entitlements, e.g., features associated with a vehicle identifier may be communicated to the vehicle cloud 300 to be processed by the cloud-to-vehicle feature manager 306 as feature activation requests for those features in the manner described above. Changes to entitlements may be published as events on the event network 322 and received by the cloud-to-vehicle feature manager 306 as a subscriber to such events.

A cloud subscriptions manager 336 in the vehicle cloud 300 may record features available for purchase. The cloud subscriptions manager 336 may manage communicating of available features to the vehicle 100 and receiving feature activation requests from the vehicle 100. Feature activation requests from the vehicle 100 may be routed to the subscriptions and billing module 330 to manage the processing of payment and the adding of paid-for features to the entitlements service 334 for the vehicle identifier of the vehicle 100 and subsequent processing as described above.

As shown in FIG. 3B, there may be different paths for a user to input a feature activation request. Using the application 302, e.g., a mobile application, a user may send a configuration change invoking one or more feature activation requests to the gateway 308 in the vehicle cloud 300, that is then routed by the cloud subscriptions manager 336 to the subscriptions and billing module 330. A configuration change invoking one or more feature activation requests may be received from the application 302 implemented as a webpage or desktop application may be transmitted to the subscriptions and billing module 330 by way of the customer web portal 332.

Various other components may be present to facilitate the functions described above. For example, the customer web portal 332 may include an order management service 338 and an upgrade service 340. The order management service 338 may receive orders for configuration changes invoking the activation of one or more features and referencing the identifier of a vehicle 100. The orders may be received from any of the applications 302. The order management service 338 notifies the upgrade service 340 of the orders. In response to the notification from the order management service 338, the upgrade service 340 may cooperate with the subscriptions and billing module 330 to process payment for orders and add feature activation requests for paid for features to the entitlements service 334 for the vehicle identifier of the vehicle 100 and subsequent processing as described above.

In some embodiments a cryptographic service 342 may be present in the vehicle cloud. The cryptographic service may, for example, encrypt messages transmitted over the event network 322, such as feature activation requests read from the feature flag database 318 for transmission to the vehicle 100 over the event network 322. The vehicle 100 may include a corresponding cryptographic service 342 for describing the feature activation requests.

FIG. 3B further illustrates the functionality described above with reference to FIG. 3A, namely the owner invoking activation of a feature of another component. For example, a feature activation request may include the CID of the XMM as the owner. The XMM receives the feature activation request and as part of processing the feature activation request determines that a feature of the ACM should also be activated. The XMM therefore transmits an event over the vehicle event network 326 that instructs the ACM to activate the feature of the ACM.

In another example, a feature activation request may enable an extended battery range. Accordingly, the BMS may be the owner of the feature activation request and send one or events over the event network 326b and/or event network 326 that invokes activation of a feature of the XMM in order to properly display the range of the battery 110 in view of the extended battery range. In some cases, the battery 110 may include a damaged cell (e.g., not balanced with respect to other cells) such that enabling of the extended battery range is not possible. The BMS may publish an event on the event network 326b that may be transmitted to the cloud-to-vehicle feature manager 306, which adds an entry to the feature flag database 318 indicating that activation of the extended battery range is not possible for the vehicle 100. Subsequent attempts to activate the extended battery range may be blocked and notifications may be sent to the application 302 indicating that activation of the extended battery range is not possible.

As shown in FIG. 3C, feature activation requests from various modalities may arrive at the subscriptions and billing module 330 by way of an order management service 338. For example, configuration changes, such as subscriptions to features, may be received by the order management service 338 from an application 302a executing on the vehicle 100, a mobile application 302b executing on a mobile device, or a webpage 302c accessed by way of a desktop or other type of computer. The order management service 338 may additionally receive subscriptions to features by way of the cloud subscriptions manager 336 (e.g., for in-vehicle feature subscriptions received from the application 302a), a consumer gateway 308a (such as for subscription requests from a mobile application 302b), or a gateway 308b, which may implement an order portal for receiving subscription requests from a webpage 302c or desktop computer application.

The consumer gateway 308a, gateway 308b, and cloud subscriptions manager 336 may enable bidirectional communication. For example, events published by a component processing a feature activation request (e.g., success or failure) may be transmitted over the vehicle event network 326 and event network 322 to any of the gateway 308a, gateway 308b and/or cloud subscriptions manager 336 and to the application 302a, mobile application 302b, and/or a webpage 302c to communicate the status of activating a subscription to the user. Likewise, available subscriptions may be published through the gateway 308a, gateway 308b and/or cloud subscriptions manager 336 and to the application 302a, mobile application 302b, and/or a webpage 302c to enable a user to select a subscription to purchase or otherwise invoke activation of a subscription. For example, the commerce platform may publish the available subscriptions.

Changes to entitlements, e.g., subscription to features, as described above may be added to a queue 348. The vehicle configuration service 304a may retrieve the subscription to features from the queue 348 and generate corresponding feature activation requests. The feature activation requests may be added to a queue 350. The cloud-to-vehicle feature manager 306 may retrieve the feature activation requests from the queue 350 and process the feature activation requests as described above.

In instances where activation of a feature is unsuccessful as described above or is otherwise discovered to be not activatable for a vehicle, this fact may be communicated to the commerce platform 304 (see FIG. 3A). Accordingly, the commerce platform 304, such as using the vehicle configuration service 304a of the commerce platform 304 may filter out attempts to access such features and may refrain from notifying the user of such features on the in-vehicle application 302a, mobile application 302b, or webpage 302c. Likewise, if a user has purchased a feature that was not successfully activated, payment for such a feature may be refunded to the user by the commerce platform 304.

The approach of FIGS. 3A to 3C may be used for various applications. For example, the vehicle management service or other entity that is part of the entity that manufactures the vehicle 100 or an external entity, such as a government agency, may push notifications to the vehicle using the infrastructure illustrated in FIGS. 3A to 3C. For example, notifications may be added to the feature flag database 318 and retrieved by the vehicle 100 when the vehicle connects to the cloud. The notifications may be routed to an ECU managing a front display 104, such as the XMM. For example, the XMM may be the owner of the notification. The notification may include executable code or other instructions that cause the XMM to display the notification and possibly receive one or more inputs and return the inputs to the vehicle cloud. Example notifications may include recall notices, service notifications (e.g., time to change tires or perform other routine maintenance), weather advisories, instructions during a natural or man-made disaster, or other information.

In addition to activating features, the approach described herein may be used to deactivate features. For example, a subscription change (e.g., cancellation) may be received from an application 302 and result in corresponding feature deactivation requests that are processed in the same manner as feature activation requests except that the owner (e.g., an ECU) that receives the feature deactivation request will deactivate a feature referenced by the feature deactivation request.

The approach described herein has primarily been described as pushing feature activation requests to a vehicle 100. However, communication in the reverse direction may also be performed. For example, a component (e.g., an ECU) may publish an event on the vehicle event network 326 indicating a failure. This event may be transmitted (e.g., by the TCM) to the event network 322. The cloud-to-vehicle feature manager may receive the event and add corresponding entries to the feature flag database, e.g., flags that indicate that features relating to the failure are not available to be activated. Subsequent attempts to add feature flags relating to activation of those features may then be suppressed in response to the flags indicating that those features are not available to be activated.

FIG. 3D illustrates an example method 360 that may be performed using the approach described herein. For example, the method 360 may be performed by the control system 206, such as by specific components of the control system 206 as described below.

The method 360 includes receiving a feature activation request at step 362, such as from the vehicle cloud 300 (e.g., from the event network 322). Step 362 may be performed by, for example, the TCM. At step 364, an event including the feature activation request is published on a vehicle event network, such as the vehicle event network 326 and/or vehicle event network 326b. Step 364 may be performed by, for example, the TCM. The event may identify an owner that is one of a plurality of components of the vehicle 100, such as an ECU. At step 366, a component, e.g., an ECU, determines that it is the owner referenced by the event and, in response executes the feature activation request at step 368. As part of executing the feature activation request, the component may publish, at step 370, one or more events on the vehicle event network 326 and/or 326b that reference one or more other components (e.g., ECUs) as owners. The one or more other components will then receive and process these events, which may include activating features of the one or more other components.

FIG. 4 illustrates a system 400 for providing proximity services to vehicles in accordance with certain embodiments. In the system 400, a plurality of vehicles 100-1, 100-2, . . ., 100-5 are wirelessly connected to a network 405. Each of the vehicles 100-1, 100-2, . . ., 100-5 represents one example of the vehicle 100, and may have identical or different configurations than each other. Further, the vehicles 100-1, 100-2, ..., 100-5 may be referred to collectively or generically as vehicle(s) 100.

The network 405 may have any suitable implementation, such as one or more wide area networks (WANs), one or more local access networks (LANs), or combinations thereof. The network 405 comprises infrastructure for communicative capability, such as conductive cabling, wireless transmission, optical transmission, and so forth. The network 405 may further comprise one or more electronic devices 410 providing network functionality and/or services to the network 405, such as routers, firewalls, switches, gateway computers, edge servers, and so forth.

As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any of a number of suitable techniques, such as conductive cabling, wireless transmission, optical transmission, and so forth. Further, although described as being performed by a single electronic device, in other aspects, the functionalities of the system 400 may be performed by a plurality of electronic devices.

As shown, the electronic device 410 comprises one or more processors 415 and a memory 420. The one or more processors 415 may include any electronic circuitry, including, but not limited to, one or a combination of microprocessors, microcontrollers, application-specific integrated circuits (ASIC), application-specific instruction set processors (ASIP), and/or state machines, that is/are communicatively coupled to the memory 420 and control(s) the operation of the electronic device 410. The one or more processors 415 are not limited to a single processing device and may encompass multiple processing devices.

The one or more processors 415 may include other hardware that operates software to control and process information. In some aspects, the one or more processors 415 execute software stored in the memory 420 to perform any of the functions described herein. The one or more processors 415 control the operation and administration of the electronic device 410 by processing information (e.g., information received from input devices and/or communicatively coupled electronic devices).

The memory 420 may store, either permanently or temporarily, data, operational software, or other information for the one or more processors 415. The memory 420 may include any one or a combination of volatile or non-volatile local or remote devices suitable for storing information. For example, the memory 420 may include random access memory (RAM), read only memory (ROM), magnetic storage devices, optical storage devices, or any other suitable information storage device or a combination of these devices. The software represents any suitable set of instructions, logic, data, or code embodied in a computer-readable storage medium. For example, the software may be embodied in the memory 420, a disk, a CD, or a flash drive. In particular embodiments, the software may include an application executable by the one or more processors 415 to perform the functionality described in greater detail below (e.g., an event service 425 and a clustering service 430).

In some embodiments, each of the vehicles 100 includes a communications stack 440 that is typically implemented in software and executed on one or more of the ECUs, such as the TCM ECU. As shown, the communications stack 440 includes a cellular stack generally representing operations at the link layer of the TCP/IP model, an Internet Protocol (IP) layer generally representing operations at the internet layer of the TCP/IP model, a vehicle-to-cloud (V2C) service generally representing operations at the transport layer of the TCP/IP model, and an event publishing service 430 and event subscriber service 450 at the application layer of the TCP/IP model. In some embodiments, the functionality of the event publishing service 430 and of the event subscriber service 450 is implemented within the vehicle feature manager of the vehicle 100, as discussed above with respect to FIGS. 3A-3C.

During operation, each of the vehicles 100 generates events related to observable changes or occurrences within the particular vehicle 100 or its environment. In some embodiments, the events include operational data for the vehicles 100 (e.g., sensor data describing internal systems of the vehicles 100), location data, environmental data such as road conditions, traffic conditions, terrain issues, weather issues (e.g., determined from sensor data from the exterior cameras 102), and so forth. In some embodiments, the various events generated by each vehicle 100 are logged by the vehicle 100 (e.g., stored in a local database).

The event publishing service 430 wirelessly communicates the events to the event service 425. In some embodiments, the functionality of the event service 425 is implemented in the cloud-to-vehicle feature manager of the vehicle cloud, as discussed above with respect to FIGS. 3A-3B, and/or in the cloud subscriptions manager of the vehicle cloud, as discussed above with respect to FIG. 3C. In some embodiments, the event service 425 logs the events in the memory 420 (e.g., stored in a database of one of the electronic devices 410).

In some embodiments, one or more of the electronic devices 410 generates events and communicates the events to the event service 425. Some non-limiting examples of the events include information about the location and/or availability of charging stations, parking information, off-roading information (e.g., trail conditions, obstacles, hazards). Further, the distribution of events may support extended communications functionality to the vehicles 100, such as broadcasting information about safety alerts or recalls to the vehicles 100, recording short audio messages that are transmitted between the vehicles 100, and so forth.

In some embodiments, the events are assigned different categories, labels, tags, etc. that indicate a relative importance or priority of the events. The assigned priority may in turn define an acceptable value or range of latency. For example, the events may be categorized as routine information or status events, alert events that inform of a particular situation requiring user attention, incident events that impact operation and require user intervention, and so forth. In some implementations, the routine information or status events may be assigned a low priority, the alert events may be assigned a medium priority, and the incident events may be assigned a high priority.

The event service 425 receives events from each of the vehicles 100, and in some cases, from the electronic device(s) 410. In some embodiments, the event service 425 performs processing on the events, such as validating the events, assigning the category or label information to the events, and so forth.

The event service 425 selectively distributes the events among other ones of the vehicles 100 according to the subscriptions specified by the event subscriber service 450 of each vehicle 100. In some embodiments, each vehicle 100 may have one or more subscriptions according to the type of the events, the priority of the events, the type of the vehicle generating the events, and so forth. For example, a particular vehicle 100 may have active subscriptions to events for road conditions and traffic conditions, all medium and high priority events, and audio recording events. In some embodiments, the event subscriber service 450 of each vehicle 100 communicates the subscription information to the event service 425.

Based on the location(s) associated with the events received by the event service 425, the clustering service 430 determines one or more geofences 435-1, 435-2 associated with the location(s). In some embodiments, the functionality of the clustering service 430 is implemented within the vehicle cloud, as discussed above with respect to FIGS. 3A-3C, e.g., within the cloud-to-vehicle feature manager or as a separate service.

The geofences 435-1, 435-2 may be referenced to a particular location, such as the location of an incident identified in the event, the location of the vehicle 100 that generated the event, and so forth. In some embodiments, the geometry of the geofences 435-1, 435-2 is uniform, such as a circle of a predetermined diameter with the reference location as the center point. In other embodiments, the geometry of the geofences 435-1, 435-2 may be determined based on information in the event. For example, a geofence 435-1, 435-2 identifying an emergency vehicle approaching along a limited-access highway may be elongated (e.g., an ellipse or other shape substantially overlapping the highway). In some embodiments, one or more size aspects of the geofence 435-1, 435-2 (e.g., a diameter, circumference, perimeter, length, etc.) may be proportional to the amount of notice to be provided to other vehicles 100. For example, the geofences 435-1, 435-2 may be larger corresponding to higher traffic speeds, a larger difference between the regular traffic speed and a slowed traffic speed, and so forth.

Based on the location(s) of the vehicles 100, the clustering service 430 defines one or more cluster(s) of the vehicles 100 that are disposed within the geofence(s) 435-1, 435-2. As shown, a first cluster of the vehicles 100-1, 100-2, 100-3 are disposed in the geofence 435-1, and a second cluster of the vehicles 100-3, 100-4, 100-5 are disposed in the geofence 435-2. The clustering service 430 updates the composition of the cluster(s), e.g., periodically, responsive to changes in vehicle locations, as events develop or are resolved, and so forth.

Based on the subscription information provided by the event subscriber service 450, the event service 425 communicates events to particular ones of the vehicles 100 within the defined clusters. Generally, all of the vehicles 100-1, 100-2, 100-3 will receive information for the event associated with the geofence 435-1 so long as they are subscribed, and all of the vehicles 100-3, 100-4, 100-5 will receive information for the event associated with the geofence 435-2 so long as they are subscribed. When a vehicle 100 enters a geofence 435-1, 435-2, it may be added to the cluster and receive information for all active event(s). When a vehicle 100 exits a geofence 435-1, 435-2, it may be removed from the cluster and no longer receives information for the event(s).

FIG. 5 illustrates a method 500 of providing proximity services to vehicles in accordance with certain embodiments. The features of the method 500 may be used in conjunction with other embodiments, e.g., using the electronic device 410 executing the event service 425 and clustering service 430 of FIG. 4.

The method 500 begins at block 505, where the electronic device 410 receives subscription information from one or more vehicles. In some embodiments, the subscription information is wirelessly transmitted between the event subscriber service 450 of the vehicle 100 and the event service 425 of the electronic device 410. In some embodiments, the subscription information indicates one or more of a type of events, a priority of events, a type of the vehicle 100 generating the events, and so forth.

At block 515, the electronic device 410 receives one or more events from the one or more vehicles. In some embodiments, the information for the one or more events is wirelessly transmitted between the event publishing service 430 of the vehicles 100 and the event service 425 of the electronic device 410.

At block 525, the electronic device 410 determines one or more locations of the vehicles 100. In some embodiments, location information indicating the one or more locations is included in the events received from the vehicles 100.

At block 535, the electronic device 410 validates the one or more events. In some embodiments, validating the one or more events includes deconflicting (or harmonizing) events that are received by different vehicles 100 (e.g., reporting a same incident), removing duplicate events, and so forth.

At block 545, the electronic device 410 defines one or more geofences based on the one or more events. In some embodiments, the one or more geofences are referenced to a location included in the location information, such as a location of an event, a location of a vehicle 100, and so forth. In some embodiments, the geometry of the one or more geofences is determined based on the event information.

At block 555, the electronic device 410 defines one or more clusters of the one or more vehicles 100 based on the one or more locations and the one or more geofences. At block 565, the electronic device 410 broadcasts information for the one or more events to the one or more subscribers in the one or more clusters. The method 500 ends following completion of block 545.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

What is claimed is:

1. A vehicle comprising:
a plurality of components; and
a controller configured to connect to a network and further configured to:
receive a feature activation request referencing an owner; and
publish an event including the feature activation request on an event network;
wherein each component of the plurality of components is configured to:
if the each component is the owner referenced by the feature activation request of the event, execute the feature activation request.

2. The vehicle of claim 1, wherein the plurality of components includes electronic control units (ECUs).

3. The vehicle of claim 1, wherein the each component is further configured to execute the feature activation request by activating a feature that is present on the each component prior to receiving the feature activation request by the controller.

4. The vehicle of claim 1, wherein the each component is further configured to execute the feature activation request without reflashing the each component.

5. The vehicle of claim 1, wherein the event network comprises a publisher/subscriber network.

6. The vehicle of claim 5, wherein the each component is a subscriber of the publisher/subscriber network and is further configured to detect the event based on the event referencing a component identifier (CID) of the each component.

7. The vehicle of claim 1, wherein the controller executes an application, the controller further configured to:
receive a configuration change from a user; and
transmit the configuration change to a remote computer system in response to the configuration change from the user;
wherein the feature activation request is received from the remote computer system in response to the configuration change.

8. The vehicle of claim 7, wherein the remote computer system is a cloud computing platform.

9. The vehicle of claim 1, wherein the each component of the plurality of components is further configured to verify that one or more interlocks are met before executing the feature activation request.

10. The vehicle of claim 1, wherein the event is a first event and the each component is further configured to execute the feature activation request by publishing one or more second events on the event network, the one or more second events referencing one or more other components of the plurality of components.

11. A method comprising:
receiving, by a vehicle controller of a vehicle, a feature activation request referencing an owner;
publishing, by the vehicle controller, an event including the feature activation request on an event network;
determining, by a component of a plurality of components of the vehicle, that the component is the owner; and
in response to determining that the component is the owner, executing, by the component, the feature activation request.

12. The method of claim 11, wherein the plurality of components includes electronic control units (ECU).

13. The method of claim 11, further comprising executing, by the component, the feature activation request by activating a feature that is present on the component prior to receiving the feature activation request by the controller.

14. The method of claim 11, further comprising executing, by the component, the feature activation request without reflashing the component.

15. The method of claim 11, wherein the event network is a publisher/subscriber network.

16. The method of claim 15, wherein the component is a subscriber of the publisher/subscriber network, the method further comprising detecting, by the component, the event due to the event referencing a component identifier (CID) of the each component.

17. The method of claim 11, further comprising:
receiving, by an application executed by the vehicle controller, a configuration change from a user; and
transmitting, by the application, the configuration change to a remote computer system in response to the configuration change from the user;
wherein the feature activation request is received from the remote computer system in response to the configuration change.

18. The method of claim 11, further comprising verifying, by the component, that one or more interlocks are met before executing the feature activation request.

19. The method of claim 11, wherein the event is a first event and the method further comprising executing, by the component, the feature activation request by publishing one or more second events on the event network, the one or more second events referencing one or more other components of the plurality of components.

20. A non-transitory computer-readable medium storing executable code that, when executed by a vehicle controller and a plurality of components of a vehicle, causes the vehicle controller and the plurality of components of the vehicle to:
receive, by the vehicle controller, a feature activation request referencing an owner;
publish, by the vehicle controller, an event including the feature activation request on an event network;
determine, by a component of the plurality of components of the vehicle, that the component is the owner; and
in response to determining that the component is the owner, execute, by the component, the feature activation request.
